(19) United States
(12) Patent Application Publication
(10) Pub. No.: US 2005/0106462 A1
(43) Pub. Date: May 19, 2005

(54) Electrochemically active positive electrode material for a lithium rechargeable electrochemical cell

(75) Inventors: Christian Jordy, Louis De Montferrand (FR); Claudette Audry, Bruges (FR); Jean-Pierre Boeuve, Montussan (FR); Philippe Biensan, Carignan de Bordeaux (FR); Andre Lecerf', Pace (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/739,165

(22) Filed: Dec. 19, 2003

(30) Foreign Application Priority Data
Nov. 17, 2003 (FR) 03 13 519

(51) Int. Cl. H01M 4/52; H01M 4/48; H01M 4/50; C01G 53/04; H01M 4/58

(52) U.S. Cl. 429/231.1; 429/223; 429/231.5; 429/221; 429/224; 429/231.3; 429/220; 429/231.6; 423/594.4; 429/231.4

(57) ABSTRACT

The present invention provides an electrochemically active material resulting from substituting a portion of the nickel in a combined nickel and lithium oxide of the LiNiO₂ type that crystallizes into a rhombohedral structure and that satisfies the formula:
Li (Ni_{(1-x-y-z-t)}CoₓMn_{y}Li_{z}Mₜ)O₂₋ₑFₑ where: 0≦x<0.70 0.05<y≦0.50 0≦z≦0.20 0≦t≦0.30 0.01<e≦0.50 0.20≦(1-x-y-z-t) and in which M is at least one element from Mg, Al, B, Ti, Si, Zr, Fe, Zn, and Cu.

The present invention relates to an electro-chemically active material for use in the positive electrode of a lithium rechargeable electrochemical cell. Naturally, the invention also applies to a positive electrode containing such an active material and to a lithium cell including such an electrode.

Lithium oxides of transition metals are known as cathode active material suitable for use in lithium cells. In the positive electrode or cathode, it is common practice to use as the active material lithium oxides of transition metals having the general formula LiₓM_{y}Ot where M is usually Mn, Ni, or Co.

More particularly, LiNiO₂ appears to be very promising because of its long lifetime and its high capacity for acceptable cost. Much work has sought to improve the characteristics of the LiNiO₂ cathode active material since it possesses a high degree of thermal instability, which constitutes a serious risk for the safety of the user. Among the solutions that have been envisaged for stabilizing the structure of LiNiO₂ during lithium insertion/desertion, the solution which is used most often is that of substituting a portion of the nickel with other elements that are less reactive.

For example, a positive electrode active material is proposed in document EP-0 918 041, that material comprising a complex lithium/nickel/cobalt oxide of formula:
Li_{y}Ni₁₋₍ₓ₁₊ₓ₂₎Coₓ₁Mₓ₂O₂
where x₁+X₂=x; 0.9≦y≦1.3; 0<x≦0.5; and X₂ depends on M; and in which M is at least one element selected from Al, Fe, Mn, and B. The stability of the active material during high temperature cycling is said to be improved in this way.

U.S. Pat. No. 6,040,090 describes a positive electrode active material of charge/discharge characteristics in cycling and of initial capacity that are improved. The formula of that active material is as follows:
LiₐCo_{b}Mn_{c}(M)_{d}Ni_{1-(b+c+d)}O₂
with 0<a<1.2; 0.01≦b≦0.5; 0.05≦c≦0.4: 0.01≦d≦0.4; and 0.15≦b+c≦0.5; and in which M is at least one element selected form B, Al, Si, Fe, V, Cr, Cu, Zn, Ga, and W. That document describes an active material which contains at least Ni, Co, and Mn and which presents an X-ray diffraction peak at 18.710±0.250 with a half-height line width less than or equal to 0.220, and with an intensity ratio for the [003] to [104] lines of: I_{[003]}/I_{[104]}≧0.8.

In order to improve all electrochemical properties, and in particular thermal stability, document EP-1 189 296 proposes a single phase cathode active material of formula:
Li[LiₓCo_{y}(Ni_{1-z}Mn_{z})_{1-x-y}]O₂
with 0<x≦0.16; 0.1≦y≦0.3; and 0.40≦z≦0.65.

The drawback of all those materials is that they are liable to become highly charged during overcharging. Consequently, the quantity of residual lithium in such overcharged materials is very small, which makes them highly thermally unstable.

All presently known active materials present thermal stability that is still insufficient for ensuring user safety. Although satisfying most tests performed under abusive conditions (external short circuit tests, nail tests, . . . ), cells containing such active materials do not withstand the overheating caused by overcharging. Under such circumstances, temperature rises considerably and suddenly due to an exothermic reaction of the active material of the electrode with the electrolyte, thereby damaging the active material.

Active materials derived from LiMnO₂ by substitution have also been studied. Nickel and cobalt oxides present the drawback of being much more expensive than manganese oxide, and furthermore, production thereof is geographically limited to high risk zones. Amongst cathode active materials, lithium-containing materials based on manganese dioxide have been the subject of numerous tests. For most materials having a spinel structure, the specific capacities of cells fall off rapidly after a few cycles. To improve the stability of such compounds, most work has been directed towards stoichiometric modifications or towards introducing a metal cation as a substitute for a portion of the manganese.

U.S. Pat. No. 5,674,645 suggests simultaneously improving cathode capacity and stability in cycling by using an active material which is an oxifluoride satisfying the following general formula:
Li₁₊ₓM_{y}Mn_{2-x-y}O_{4-z}F_{z}
with x≦0.4; y≦0.3; and 0.05≦z≦1.0; and where M is a transition metal such as Co, Cr, or Fe.

In recent lithium rechargeable cells, the carbon of the anode has been replaced by an inorganic compound, thereby leading to irreversible losses of lithium. The use of LiMnO₄ as cathode active material has shown that it is capable of supplying an excess quantity of lithium, enabling such losses to be compensated in part.

For example, U.S. Pat. No. 6,432,581 describes a cathode active material which is an intercalation compound having the following formula:
Li₂Mn₂₋ₓMeₓO_{4-z}F_{z}
with 0≦x≦0.5; and 0≦z≦0.5; and where M is selected from Al, Cr, Zn, Co, Ni, Li, Mg, Fe, Cu, Ti, Si, or a combination thereof.

In the voltage range required by applications (Uc/Ud=1.5 with Uc=4.3 V versus Li⁺/Li°, where Uc is the charging cutoff voltage and Ud is the discharge cutoff voltage), the materials described in U.S. Pat. Nos. 5,674,645 and 6,432,581 present reversible electro-chemical capacity that is too small (<125 milliampere hours per gram (mAh/g)).

Document EP-1 225 650 describes a positive active material containing a composite material having the following general formula:
Liₓ(Ni_{1-y}Mel_{y})(O_{2-z}X_{z})+A
with 0.02≦x≦1.3; 0.005≦y≦0.5; 0.01≦z≦0.5; in which Mel is at least one element selected from B, Mg, Al, Sc, Ti, V, Cr, Mn, Co, Cu, Zn, Ga, Y, Zr, Nb, Mo, Tc, Ru, Sn, La, Hf, Ta, W, Re, Pb, and Bi, where X is at least one halogen selected from F, Cl, Br, and I, and where A contains at least one element selected from Na, K, and S, the content of each of these elements lying in the range 600 parts per million (ppm) to 3000 ppm.

Cells containing such materials present improved results in the nail test and in rapid discharging. However, the thermal stability of those materials in overcharging is insufficient.

Document JP-10 326 621 describes a positive active material having the following general formula:
Liₓ(Ni_{1-y}M_{y})O_{2-z}Xₐ
with 0.2<x<1.2; 0<y<0.5; 0<z<1; and 0<a<2z; where M is an element belonging to group 2, 13, and/or 14, and is a transition element; and where X is a halogen element.

Those cells provide high capacity at low cost. However, most of those cells present poor thermal stability in overcharging.

Document EP-1 130 663 describes a positive active material having the following formula:
Li₁₋ₓM O_{2-y-δ}F_{y}
where M=Mn or a combination of Mn with a substitution element such as Co, Ni, Cr, Fe, Al, Ga, or In, and in which 0<x<1; and 0<y.

This family of materials, which is very rich in manganese, crystallizes into an orthorhombic structure and presents charging efficiency of less than 80% when the cell is cycled between 3 V and 4.3 V because of the fact that it becomes transformed into a spinel structure during electrochemical cycling. Furthermore, their cycling lifetime is very mediocre (fewer than 160 cycles).

An object of the present invention is to propose a rechargeable electrochemical cell providing increased user safety in the event of accidental overcharging when compared with presently known cells, while retaining high reversible capacity and long lifetime in cycling. In particular, an object of the invention is to propose an electrochemically active material whose thermal stability, in particular during high rate overcharging, is improved so as to minimize the reaction between the active material and the electrolyte and limit the thermal runaway that results therefrom.

The present invention provides an electrochemically active material resulting from substituting a portion of the nickel of a composite nickel and lithium oxide of the LiNiO₂ type. The active material of the invention is an oxide that crystallizes in a rhombohedral structure and satisfies the following formula:
Li(Ni_{(1-x-y-z-t)}CoₓMn_{y}Li_{z}Mₜ)O₂₋ₑFₑ
where:
0≦x<0.70
0.05<y≦0.50
0≦z≦0.20
0≦t≦0.30
0.01<e≦0.50
0.20≦(1-x-y-z-t)
   and in which M is at least one element from Mg, Al, B, Ti, Si, Zr, Fe, Zn, and Cu.

Cells having a positive electrode whose active material is derived from LiNiO₂ react violently during overcharging, since that material becomes highly thermally unstable, which means that it has a low thermal runaway temperature and an exothermic reaction of high energy and thermal power. As a result, storage batteries containing such a known active material present overcharging characteristics that are not satisfactory.

The positive active material described in the invention presents characteristics in the overcharged state that are quite surprising: the total energy and thermal power developed are very small compared with known materials derived from LiNiO₂. They enable electro-chemical cells to be made that are safe, however abusive the conditions to which they are subjected, in particular overcharging.

In a first implementation of the invention, preferably 0.05<x≦0.30.

In a second implementation of the invention, preferably 0.20<y≦0.40.

In a third implementation of the invention, preferably 0.05<z≦0.15.

In a fourth implementation of the invention, preferably 0.01<t≦0.10.

In a fifth implementation of the invention, preferably 0.01<e≦0.30.

In a first embodiment of the present invention, M contains at least Mg.

In a second embodiment of the present invention, M contains at least Al.

In a third embodiment of the present invention, M contains at least B.

In a fourth embodiment of the present invention, M contains at least Si.

In a fifth embodiment of the present invention, M contains at least Ti.

Preferably, the active material of the invention is a lamellar oxide substituted with substantially single-phase Ni, Co, and Mn, the optional presence of a minority second phase remaining less than 3% by weight of the active material, and preferably less than 1%.

The present invention also provides a positive electrode for a lithium rechargeable electrochemical cell, the electrode comprising a conductive support covered in an active layer containing the above-described active material. The active layer may also contain a binder and/or a conductive material.

The present invention also provides a lithium rechargeable electrochemical cell including a positive electrode containing the above-described active material and a negative electrode whose active material is selected from metallic lithium and alloys of lithium with a material suitable for inserting lithium in its structure. The active material of the negative electrode may be constituted in particular by a carbon-based material suitable for inserting lithium in its structure, said material being selected from graphite, coke, carbon black, and vitreous carbon.

Other characteristics and advantages of the present invention appear from the following embodiments, naturally given by way of non-limiting illustration, and from the accompanying drawings, in which:

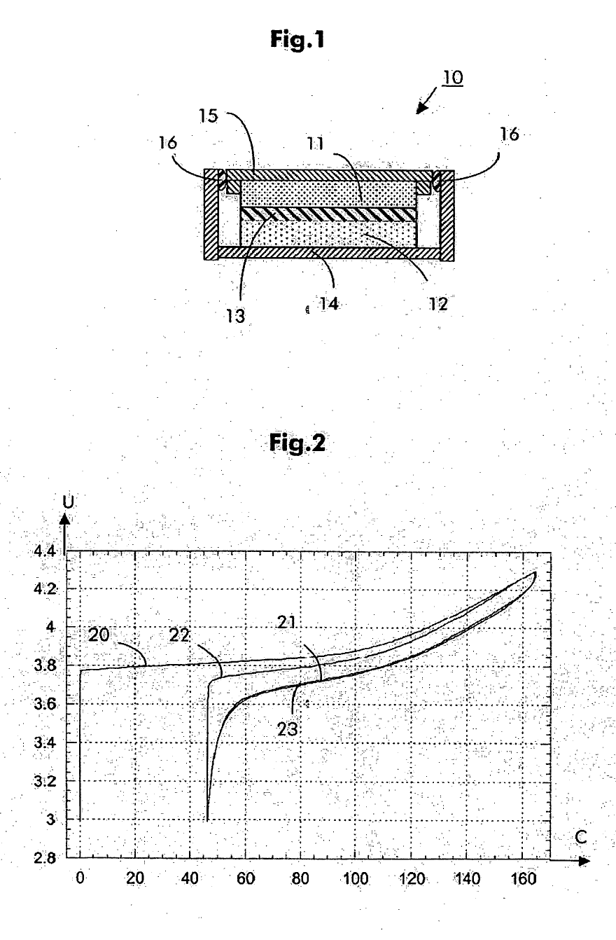

FIG. 1 is an exploded diagrammatic section of an electrochemical cell of the button type including an electrochemically active material of the invention;

FIG. 2 shows two first charge/discharge curves for an electrochemical cell containing an electro-chemically active material of the invention having the formula:
Li(Ni_{0.52}Mg_{0.02}Mn_{0.30}CO_{0.16})O_{1.87}F_{0.13};

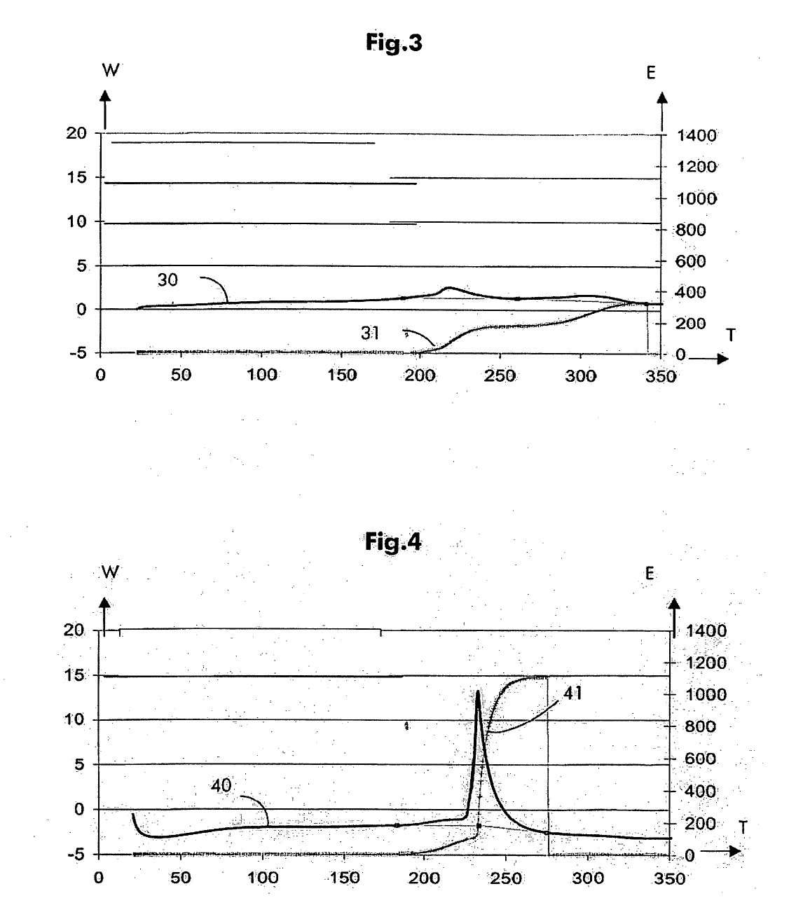

FIG. 3 shows a curve obtained by differential scanning calorimetry (DSC) applied to an electrode containing an electrochemically active material of the invention in the overcharged state and having the formula:
Li(Ni_{0.52}Mg_{0.2}Mn_{0.30}Co_{0.16})O_{1.87}F_{0.13}; and

FIG. 4 is analogous to FIG. 3, showing a curve obtained using the same DSC method for an electrode containing an active material that does not form part of the present invention, that is in the overcharged state, and that has the following formula:
Li_{1.10}Ni_{0.88}Mg_{0.02}O_{1.9}F_{0.1}+Na 3000 ppm

In FIG. 2, the charged or discharged capacity C of the active material in mAh/g is plotted along the abscissa and the voltage U of the cell is plotted up the ordinate in volts.

In FIGS. 3 and 4, the thermal power W of the active material is plotted in watts per gram (W/g) up the left-hand ordinate, the accumulated thermal energy E of the active material is plotted in joules per gram (J/g) up the right-hand ordinate, and temperature T is plotted along the abscissa in ° C.

### EXAMPLES 1 TO 9

Active materials of the invention were prepared in the manner described below with formulae as given in Table 1 below.

TABLE 1

| Example | Formula |
|---|---|
| 1 | Li(Li_{0.10}Ni_{0.40}Mn_{0.36}Co_{0.14})O_{1.96}F_{0.04} |
| 2 | Li(Ni_{0.52}Mg_{0.02}Mn_{0.30}Co_{0.16})O_{1.87}F_{0.13} |
| 3 | Li(Li_{0.10}Ni_{0.40}Mn_{0.36}Co_{0.14})O_{1.80}F_{0.20} |
| 4 | Li(Li_{0.10}Ni_{0.39}Mn_{0.36}Co_{0.15})O_{1.70}F_{0.30} |
| 5 | Li(Li_{0.10}Ni_{0.35}Mn_{0.35}Co_{0.15}Al_{0.02}B_{0.03})O_{1.80}F_{0.20} |
| 6 | Li(Li_{0.10}Ni_{0.35}Mn_{0.35}Co_{0.15}Ti_{0.05})O_{1.80}F_{0.20} |
| 7 | Li(Li_{0.10}Ni_{0.35}Mn_{0.35}Co_{0.15}Si_{0.05})O_{1.80}F_{0.20} |
| 8 | Li(Li_{0.10}Ni_{0.35}Mn_{0.35}Co_{0.15} Zn_{0.05})O_{1.80}F_{0.20} |
| 9 | Li(Li_{0.05}Ni_{0.35}Mn_{0.30}Co_{0.30})O_{1.80}F_{0.20} |

### COMPARATIVE EXAMPLES 1 TO 9

The comparative active materials whose formulae are given in Table 2 below were also prepared in the manner described below.

TABLE 2

| Comparative example | Formula |
|---|---|
| C1 | Li(Ni_{0.90}Co_{0.01}Mn_{0.09})O₂ |
| C2 | Li_{1.064}(Mn_{0.416}Ni_{0.415}Co_{0.169})_{0.936}O₂ |
| C3 | Li_{1.10}Ni_{0.88}Mg_{0.02}O_{1.9}F_{0.1} + Na 3000 ppm |
| C4 | LiNi_{0.93}Mn_{0.04}B_{0.03}O_{1.9}F_{0.1} |
| C5 | Li(Ni_{0.52}Mg_{0.02}Mn_{0.30}Co_{0.16})O₂ |
| C6 | Li(Ni_{0.46}Mn_{0.40}Co_{0.14})O_{1.4}F_{0.6} |
| C7 | Li(Ni_{0.30}Mn_{0.30}Co_{0.10}Li_{0.30})O_{1.87}F_{0.13} |
| C8 | Li(Ni_{0.30}Mn_{0.30}Co_{0.10}Ti_{0.30})O_{1.87}F_{0.13} |

Preparation of the Electrochemically Active Material

The active materials of the invention of formula Li(Ni_{(1-x-y-z-t)}CoₓMn_{y}Li_{z}Mₗ)O₂₋ₑFₑ were synthesized using a carbonated promoter prepared from a mixture of metal salts in stoichiometric proportion. After reacting, the resulting precipitate was filtered and dried. Thereafter lithium carbonate Li₂CO₃ was used as a lithiating agent and lithium fluoride LiF as a source of fluorine, which ingredients were mixed vigorously by mechanical means with the carbonated promoter in stoichiometric proportion. Heat treatment was then performed in a furnace under a flow of oxygen at 900° C. for 24 hours (h).

The comparative active materials were prepared in the manner described above, except for comparative test C3 in which LiOH.H₂O and LiF were used respectively as the source of lithium and as the source of fluorine in stoichiometric proportion; 3000 ppm of potassium in the form of KOH were added. After mixing mechanically for 30 minutes, first heat treatment was performed at 480° C. under a flow of oxygen for 10 h, followed by second heat treatment at 700° C. for 20 h under oxygen.

Characterization of the Electrochemically Active Material

The active materials of the present invention in Examples 1 to 9 above are substantially single-phase. The quantity of the second phase that might be present is less than 3% by weight of the active material. X-ray diffraction analysis shows that the active material crystallizes in the rhombohedral structure. For example, starting from the X-ray diffraction pattern of the active material of Example 2, the lattice parameters of the lamellar structure were determined as follows: a=2.8825 angstroms (Å) and c=14.27 Å.

The active materials corresponding to the comparative examples C1 to C8 also crystallize into the rhombohedral structure, however they are not single-phase. In comparative examples C6 to C8, the quantity of the second phase is well above 3%.

Making an Electrode

A positive electrode for a lithium rechargeable cell is made as follows. A paste is prepared by mixing 86% by weight of electrochemically active material, 6% by weight of polyvinylidene fluoride (PVDF) and 8% by weight of a carbon containing conductive material, preferably a mixture comprising 4% soot and 4% graphite, in N-methylpyrolidone (NMP). The resulting paste is deposited on an aluminum foil which acts as a conductive support for the electrode. The electrode is then dried at 140° C. for 1 h, and then calendared.

Assembling an Electrochemical Cell

A positive electrode as prepared above is used for making a rechargeable electrochemical cell of button format. To form the electrochemical cell 10 shown in FIG. 1, a cathode 11 containing an electrochemically active material of the invention is assembled facing an anode 12 constituted by a foil of metallic lithium. The positive and negative electrodes 11 and 12 are on opposite sides of a separator 13 constituted by a polyethylene (PE) membrane sold by the supplier “CELGARD”. The electrochemical couple obtained in this way is placed in a cup 14 closed in leaktight manner by a cover 15 via a gasket 16. The electrochemical couple is impregnated in an electrolyte which is a mixture of propylene carbonate, ethylene carbonate, and dimethyl carbonate (PC/EC/DMC) in volume proportions 1/1/3, and containing lithium hexafluorophosphate LiPF₆ and molar concentration (1M). The cell is assembled and filled with electrolyte in a glove box under an argon atmosphere that is free from humidity.

Electrochemical cells were made in the above manner comprising the active materials of the invention of Examples 1 to 9, and cells were also made comprising the active materials of comparative examples C1 to C8.

Electrochemical Evaluation of the Cells

Each cell was subjected to two charges and to two discharges in succession between 3 V and 4.3 V at ambient temperature at a rate of 0.015 Ic, where Ic is the current that would theoretically be required to discharge the cell in 1 h.

Tables 3 and 4 summarize the electrochemical results obtained respectively with the active materials of Examples 1 to 9 and with the active materials of the comparative examples C1 to C8. The electrochemical capacities discharged in the first cycle for the active materials of Examples 1 to 9 were greater than 120 mAh/g. The electrochemical capacities of the active materials of comparative examples C1 to C5 were also high (greater than 120 mAh/g) whereas the electrochemical capacities of the active materials of comparative examples C6 to C8 were low (less than 100 mAh/g).

FIG. 2 shows the results obtained for a cell containing the active material of the invention of Example 2. The figure shows the following: curve 20 for the first charge; curve 21 for the first discharge; curve 22 for the second charge; and curve 23 for the second discharge. During the first cycle, the capacity charged was 165 mAh/g and the capacity discharged was 120 mAh/g.

The active material of the invention of Example 2 was also tested in another type of cell. A rechargeable electrochemical cell of button format was assembled analogous to that described above except that the negative electrode was a carbon electrode. A mixture was made comprising 96% by weight of graphite, 2% by weight of sytrene-butadiene rubber (SBR), and 2% by weight of carboxymethylcellulose (CMC). A paste was obtained having viscosity that was adjusted using a solvent. The resulting paste was then deposited on a copper foil. The negative electrode was designed in such a manner that the capacity of the negative electrode was equal to one-third the capacity of the positive electrode.

On the first cycle, the charged capacity of the positive electrode was 165 mAh/g. Its reversibly dischargeable capacity was 115 mAh/g. It can be seen that in the present case, the result obtained for a cell containing a carbon negative electrode is of the same order as that obtained for a cell containing a metallic lithium electrode.

Characterization of the Electrode

The thermal stability of the previously prepared electrochemically active materials was measured by the DSC method. The DSC method is a technique for determining how thermal flux varies in a sample subjected to temperature programming. When a material is heated, its structure changes and the transformation take place with exchange of heat. In the present case, an exothermic reaction is observed between the oxygen given off by the positive material and the electrolyte. DSC analysis provides information on the transformation temperature of the material (endothermic or exothermic peak), on the thermal power that is developed (height of the peak), and on the thermal energy required for the transformation (area of the peak above the baseline).

After two charge/discharge cycles at ambient temperature performed under the conditions described above, charging was performed at 0.05 Ic until the voltage of the cell reached 4.3 V, and was then followed by overcharging at 0.2 Ic for 5 h. 3 milligrams (mg) of active material in the overcharged state was then taken from the electrolyte-impregnated positive electrode. The sample of active material was heated from 20° C. to 500° C. at a rate of 10° C. per minute under argon. DSC analysis provided information concerning the thermal stability of the active material in the overcharged state, and thus on the behavior of the electrode relative to the electrolyte.

In DSC analysis, the following parameters characterized the thermal stability of the material:
W the thermal power given off in W/g of active material; when the amplitude of variations in W relative to the baseline exceeds 5 W/g, the reactions which take place become violent;
Tp is the temperature in ° C. at which the violent reaction takes place between the overcharged active material and the electrolyte; and
E is the accumulated thermal energy in J/g of the active material as a function of temperature (calculated relative to the baseline).

Table 3 gives the maximum thermal power amplitudes (heights of the DSC peaks relative to the baseline) and also the total energies of the active materials in the overcharged state for Examples 1 to 9. In all of these examples, the thermal power is very low (less than 3 W/g) and the total energy is less than 450 J/g.

Table 4 gives the maximum thermal power amplitudes (heights of the DSC peaks relative to the baseline) and also the total energies of the active materials in the overcharged state for comparative examples C1 to C8. For comparative examples C1 to C5 which presented a discharged capacity in the first cycle greater than 120 mAh/g, the maximum thermal power amplitude was very high (greater than 7 W/g), and the total energy was greater than 900 J/g. For comparative examples C6 to C8, the maximum thermal power amplitude was very low and the total energy was less than 350 J/g, but the capacity discharged on the first cycle was less than 100 mAh/g.

FIG. 3 shows the results of the DSC test as follows: a curve 30 for thermal power W; and a curve 31 for accumulated thermal energy E both as a function of temperature T, estimated using as the baseline a curve 32 for an overcharged electrode comprising the active material of Example 2.

FIG. 4 shows a curve 40 of thermal power W and a curve 41 of total thermal energy E as a function of temperature T, derived from the DSC tests on an electrode comprising the comparative active material of Example C3.

The results of the DSC tests of FIGS. 3 and 4 show clearly that an active material of the present invention presents thermal stability that is better than that of comparative active material that does not form part of the invention. The comparative active material presents a thermal power amplitude of about 13 W/g with an accumulated thermal energy of 1100 J/g, whereas the active material of the invention presents a maximum thermal power of less than 3 W/g and an accumulated thermal energy of less than 400 J/g. The electro-chemically active material of the present invention thus presents thermal stability characteristics that are greatly improved compared with the comparative active material, and also presents high reversible electro-chemical capacity.

Naturally, the present invention is not limited to the embodiments described, but can be subjected to numerous variants available to the person skilled in the art without departing from the spirit of the invention. In particular, without going beyond the ambit of the invention, it is possible to envisage using a conductive support for the electrode of different structure and kind. Finally, the various ingredients used in making the paste, and the relative proportions thereof could be changed. In particular, additives for making the electrode easier to shape, such as a thickening agent or a texture-stabilizing agent could be incorporated therein in small quantities.

TABLE 3

| | | | | Maximum thermal | |
|---|---|---|---|---|---|
| | | | | power ampltude in | Total thermal |
| | | Capacity | Capacity | the overcharged | energy in the |
| | | charged on | discharged on | state, measured by | overcharged state |
| | | first cycle | first cycle | DSC | measured by DSC |
| Example | Formula | (mAh/g) | (mAh/g) | (W/g) | (J/g) |
| 1 | Li(Li_{0.10}Ni_{0.40}Mn_{0.36}Co_{0.14})O_{1.96}F_{0.04} | 153 | 133 | 0.85 | 300 |
| 2 | Li(Ni_{0.52}Mg_{0.02}Mn_{0.30} Co_{0.16})O_{1.87}F_{0.13} | 165 | 120 | 1.2 | 350 |
| 3 | Li(Li_{0.10}Ni_{0.40}Mn_{0.36}Co_{0.14})O_{1.80}F_{0.20} | 157 | 130 | 2.8 | 450 |
| 4 | Li(Li_{0.10}Ni_{0.39}Mn_{0.36} Co_{0.15})O_{1.70}F_{0.30} | 160 | 135 | 0.8 | 300 |
| 5 | Li(Li_{0.10}Ni_{0.35}Mn_{0.35}Co_{0.15}Al_{0.02}B_{0.03})O_{1.80}F_{0.20} | 153 | 125 | 1.1 | 370 |
| 6 | Li(Li_{0.10}Ni_{0.35}Mn_{0.35}Co_{0.15}Ti_{0.05})O_{1.80}F_{0.20} | 155 | 127 | 0.95 | 310 |
| 7 | Li(Li_{0.10}Ni_{0.35}Mn_{0.35}Co_{0.15}Si_{0.05})O_{1.80}F_{0.20} | 157 | 130 | 1.2 | 380 |
| 8 | Li(Li_{0.10}Ni_{0.35}Mn_{0.35}Co_{0.15}Zn_{0.05})O_{1.80}F_{0.20} | 155 | 125 | 1.7 | 400 |
| 9 | Li(Li_{0.05}Ni_{0.35}Mn_{0.30}Co_{0.30})O_{1.80}F_{0.20} | 163 | 130 | 2 | 410 |

TABLE 4

| | | | | Maximum thermal | |
|---|---|---|---|---|---|
| | | | | power ampltude in | Total thermal |
| | | Capacity | Capacity | the overcharged | energy in the |
| | | charged on | discharged on | state, measured by | overcharged state |
| Comparative | | first cycle | first cycle | DSC | measured by DSC |
| example | Formula | (mAh/g) | (mAh/g) | (W/g) | (J/g) |
| C1 | Li(Ni_{0.90}Co_{0.01}Mn_{0.09})O₂ | 195 | 178 | 20 | 1300 |
| C2 | Li_{1.064}(Mn_{0.416}Ni_{0.415}Co_{0.169})_{0.936}O₂ | 185 | 160 | 7 | 900 |
| C3 | Li_{1.10}Ni_{0.88}Mg_{0.02}O_{1.9}F_{0.1} + Na 3000 ppm | 160 | 120 | 13 | 1050 |
| C4 | LiNi_{0.93}Mn_{0.04}B_{0.03}O_{1.9}F_{0.1} | 183 | 130 | 10 | 1150 |
| C5 | Li(Ni_{0.52}Mg_{0.02}Mn_{0.30}Co_{0.16})O₂ | 180 | 157 | 15 | 900 |
| C6 | Li(Ni_{0.46}Mn_{0.40}Co_{0.14})O_{1.4}F_{0.6} | 135 | 95 | 0.8 | 310 |
| C7 | Li(Ni_{0.30}Mn_{0.30}Co_{0.10}Li_{0.30})O_{1.87}F_{0.13} | 110 | 90 | 1 | 350 |
| C8 | Li(Ni_{0.30}Mn_{0.30}Co_{0.10}Ti_{0.30})O_{1.87}F_{0.13} | 105 | 80 | 1.1 | 300 |

1. An electrochemically active material crystallizing in a rhombohedral structure and resulting from substituting a portion of the nickel of a composite nickel and lithium oxide of the LiNiO₂ type, said active material being characterized in that it satisfies the formula:
Li(Ni_{(1-x-y-z-t)}CoₓMn_{y}Li_{z}Mₜ)O₂₋ₑFₑ
where
0≦x<0.70
0.05<y≦0.50
0≦z≦0.20
0≦t≦0.30
0.01<e≦0.50
0.20≦(1-x-y-z-t)
and in which M is at least one element from Mg, Al, B, Ti, Si, Zr, Fe, Zn, and Cu.

2. An active material according to claim 1, in which 0.05<x≦0.30.

3. An active material according to claim 1, in which 0.20<y≦0.40.

4. An active material according to claim 1, in which 0.05<z≦0.15.

5. An active material according to claim 1, in which 0.01<t≦0.10.

6. An active material according to claim 1, in which 0.01<e≦0.30.

7. An active material according to claim 1, in which M contains at least Mg.

8. An active material according to claim 1, in which M contains at least Al.

9. An active material according to claim 1, in which M contains at least B.

10. An active material according to claim 1, in which M contains at least Si.

11. An active material according to claim 1, in which M contains at least Ti.

12. An active material according to claim 1, comprising substantially a single phase.

13. An active material according to claim 12, in which the quantity of any second phase is less than 3% by weight of said active material.

14. An active material according to claim 13, in which the quantity of any second phase is less than 1% by weight of said active material.

15. A positive electrode for a lithium rechargeable electro-chemical cell, the electrode comprising a conductive support covered in an active layer containing an active material according to claim 1.

16. A positive electrode according to claim 15, in which said active layer also contains a binder.

17. A positive electrode according to claim 15, in which said active layer also contains a conductive material.

18. A lithium rechargeable electrochemical cell including a positive electrode containing an active material according to claim 14 and a negative electrode whose active material is selected from metallic lithium, and alloys of lithium and a material capable of inserting lithium in its structure.

19. An electrochemical cell according to claim 18, including a negative electrode whose active material is a carbon-containing material capable of inserting lithium in its structure.

20. An electrochemical cell according to claim 19, in which said carbon-containing material is selected from graphite, coke, carbon black, and vitreous carbon.
